(19) United States
(12) Patent Application Publication
(10) Pub. No.: US 2009/0001231 A1
(43) Pub. Date: Jan. 1, 2009

(54) Nesting Elevated Pet Feeder Stands

(76) Inventor: Joseph Casanova, Parker, CO (US)

Correspondence Address: Leyendecker & Lemire, LLC, C/O PORTFOLIO IP, P.O. BOX 52050, MINNEAPOLIS, MN, 55402, US

(21) Appl. No.: 11/771,630

(22) Filed: Jun. 29, 2007

(51) Int. Cl. B65D 21/00; B65B 35/50; F16M 11/00

(52) U.S. Cl. 248/176.1; 119/61.5; 206/499; 53/396

(57) ABSTRACT

An elevated pet feeding bowl stand is described along with a set of stands of different sizes that are nestable within each other for shipment and retail display. One variation of the stand comprises a rectangular form substantially fabricated from a single piece of the transparent plastic sheet. Multiple sizes are provided wherein each smaller size nests within the next larger size.

### FIELD OF THE INVENTION

The present invention relates generally to pet products.

### BACKGROUND

Research has shown that the health of a dog, and other pets, can be improved by providing a feeding position which is raised above the ground or floor. This reduces or eliminates the need for the dog to position its' head downward during feeding. Among the benefits of an elevated feeding position are that the dog swallows less air during feeding. Moreover, dogs suffering from arthritis or reduced neck mobility can feed more comfortably. Overall, an elevated feeding position provides a more convenient feeding position.

Numerous types of elevated stands are available in the marketplace. Many are fixed height stands in which a pet owner must purchase the correct size stand based on the height of the dog. One known formula states that the height of the top of a stand should be about 4-6 inches lower than the height of a dog's wither. To accommodate the variety of breeds currently popular in the United States alone four or more sizes of feeder stands would have to be stocked by each pet store that sells elevated stands. Relative to many pet products, these stands can be large and take up a significant amount of shelf or floor space in a pet shop. To make matters worse, the large and bulky stands can be expensive to ship, significantly reducing a shop owner's gross profit margin on a stand. Accordingly, a shop may only stock one or two sizes of elevated feeder stands, allocating valuable shelf and floor space to smaller products with higher gross margins. Accordingly, the pet owner can be severely limited in his/her ability to find a stand of the appropriate height for his or her pet.

Height adjustable feeder stands are also available but for one reason or another have not proven to be particularly successful in the marketplace. For one, they are relatively large and as such cause many of the same display and shipping issues as fixed height stands. Also, for whatever reason, consumers tend to shy away from adjustable products in which the consumer will never need to make future adjustments after the first. Perhaps many consumers are loath to pay for additional features and complexity that they will not have any use for once the unit is set up: they would rather purchase a less expensive unit permanently configured for their intended use. Speculatively, perhaps the most significant reason adjustable feeder stands have not been particularly successful in the market is that they are generally unattractive. Simply, many people do not want them in their dwellings.

### BRIEF DESCRIPTION OF THE DRAWINGS

FIG. 1 is an isometric view of an elevated pet feeder without the feeding bowls included therein according to an embodiment of the present invention.

FIG. 2 is an isometric view of an elevated pet feeder with the feeding bowls included therein as packaged according to an embodiment of the present invention.

FIG. 3 is side view of a corner section of an elevated pet feeder according to an embodiment of the present invention.

FIG. 4 is an isometric view of a plurality of differently sized elevated pet feeders according to an embodiment of the present invention.

FIG. 5 is an isometric view of a plurality of differently-sized elevated pet feeders packaged for one or both of shipment or display according to an embodiment of the present invention.

### DETAILED DESCRIPTION

Embodiments of the present invention comprise a single piece (save for footpads) pet feeder stand adapted to hold one or two pet feeding bowls depending on the variation. The stand is typically constructed from a clear or translucent sheet of thermoplastic material, such as acrylic, that is thermoformed into a substantially rectangular shape. Typically, one or two circular openings are provided in the horizontally-orientated top side for receiving and retaining pet feeding bowls therein. The ends of the formed sheet are typically adhesively joined at a bottom corner or in the middle of the bottom side. In some variations, a thin strip of acrylic sheet is used to create a lap joint at the seam. Rubber or synthetic rubber footpads are attached to the bottom side of the stand to prevent the stand from sliding around, especially on hard floor surfaces when being used by a dog or other type of pet. The shape of the rubber footpads are typically square or round, or can be configured in other shapes including but not limited to, a dog paw print shape. The color of the footpads is typically black, white, or clear, or can be provided in any other suitable colors as well.

Advantageously, since the stand is typically comprised of a clear material, it does not interfere or clash with a residence's décor any more than one or two feeding bowls do by themselves. Rather, the stand is simple and unobtrusive, yet the elevated feeding bowls, which are typically opaque, provide sufficient visual stimuli to prevent people within the house from accidentally colliding with or tripping over the stand.

In some embodiments, one or more stickers or decals printed on a clear or translucent polymeric sheet stock are provided with or sold separately from the stand to permit the purchaser to adorn or decorate the stand as he/she sees fit. The stickers depict any suitable images such as, but not limited to: caricatures of dogs, cats, birds and insects; paw prints and sports team identifiers and logos.

For retail sale, some embodiments of the stand include one or more feeding bowls often but not necessarily comprised of stainless steel. The body of the bowl is received in a corresponding circular opening with the flanged lip of the bowl resting on the edge of circular opening. To hold the bowls in place during shipment and during the display of the product, a sheet, typically comprising a cardboard or other paper product is wrapped over the top surface of the top side at least partially overlapping the bowls with the widthwise edges overlapping and being adhesively or mechanically secured below the bottom surface of the top side. The cardboard typically includes product information including a sizing chart, trademarks and name of the manufacturer. Other suitable material can also be included. In variations, the cardboard sheet may be replaced with a plastic band that may be shrunk in place. In any of the variations, the overlapping of the bowls helps to hold the bowls in place to minimize the risk that they will become separated from the stand prior to sale of the stand.

The stands can be produced in a plurality of sizes. In one embodiment, a complete set of all stands in all sizes comprises eight stands. In another embodiment, the total number of differently sized stands comprises five standard sizes, although other embodiments and variations are contemplated, comprising sets of any suitable number of stands. In other variations, a complete set of stands may comprise a greater or lesser number of differently sized units.

Whatever the number in a set, each smaller member of the set is adapted to nest substantially within the interior space defined by the next larger member of the set. Accordingly, a complete set of stands can be shipped in a single box, significantly reducing required shipping volume attributable to shipping a plurality of differently sized stands, compared to prior art stands that must either be shipped in separate boxes or in much larger boxes because they do not nest efficiently. Also advantageously, the product can be stored and displayed in the nested fashion, thereby saving on warehousing expense for the manufacturer and any distributors, as well as maximizing the retailer's utilization of limited shelf and/or floor space. By reducing a retailer's shipping expense to order and receive a set of stands and by minimizing the required retail display space, the retailer's return is enhanced over prior art products, thereby increasing the probability it will stock more than just one or two sizes of elevated feeder stands.

### Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “one variation”, “a variations” and similar phrases mean that a particular feature, structure, or characteristic described in connection with the embodiment is included in at least an embodiment of the invention. The appearance of the phrase “in one embodiment” or “in an embodiment” in various places in the specification are all not necessarily meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

As used herein, the terms “nest”, “nesting”, “nestable” and “nested” refers to placing a first smaller object (herein a elevated pet feeder bowl stand or stand assembly) within a larger second object of the same generally type wherein the first object is substantially contained within a volume defined by the second object.

### AN EMBODIMENT OF A TRANSPARENT ELEVATED PET FEEDING STAND

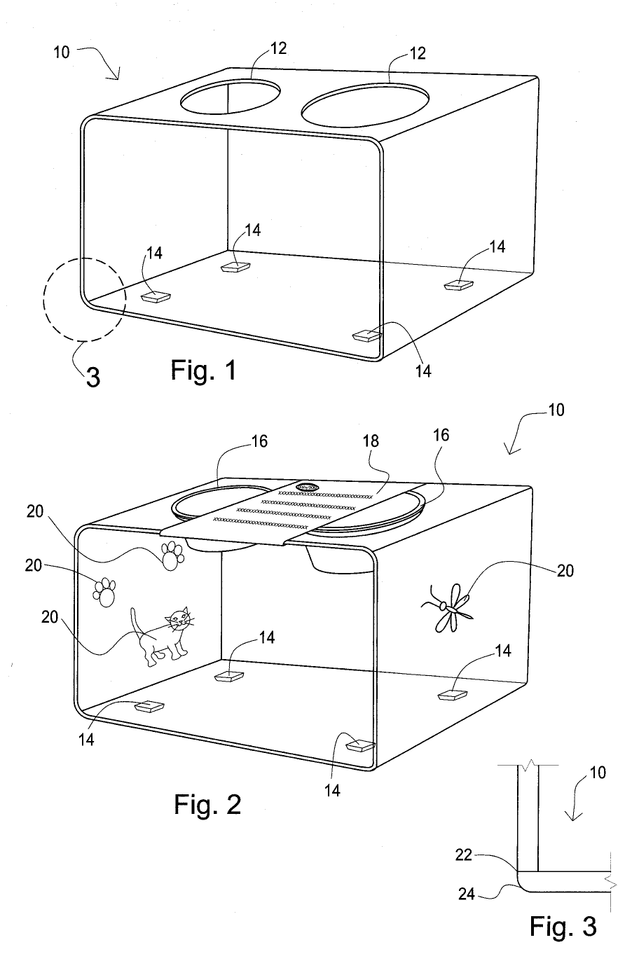

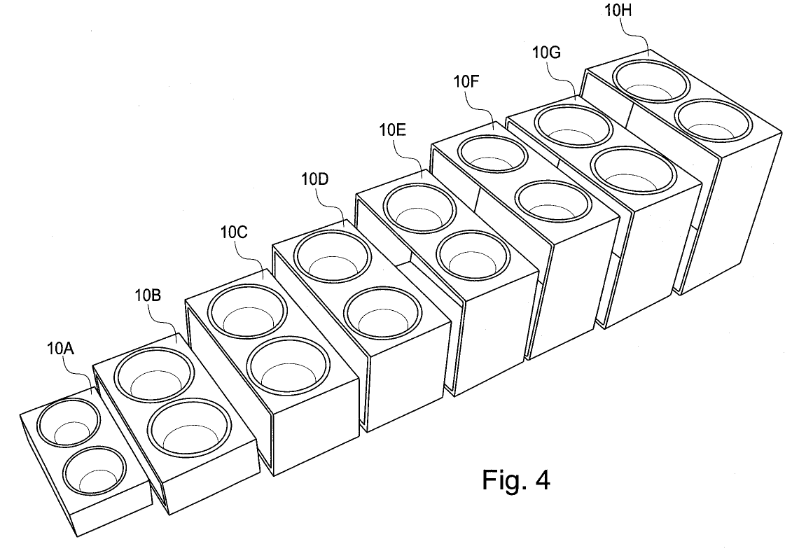

FIGS. 1 and 2 are illustrations of an embodiment 10 of the elevated pet feeder bowl stand. FIG. 1 illustrates the stand unadorned with feeding bowls 16 and packaging while FIG. 2 shows a variation of the stand as packaged for shipping, and retail display and sale. FIG. 3 illustrates a bottom corner wherein the ends of the thermoformed sheet that forms the stand are joined in one variation.

Referring primarily to FIG. 1, the stand 10 substantially comprises a single sheet of a transparent thermoplastic polymeric material that in some variations is about 0.250″ thick. One suitable sheet material is transparent acrylic, which is more often referred to by the trade name Plexiglas™. Another suitable sheet material is transparent polycarbonate, which is often referred to by the trade name Lexan™. Translucent and opaque versions of the above-mentioned materials or other thermoplastic polymeric materials can be also used.

To form the rectangular shape of the stand 10, the plastic sheet is heated until it becomes suitably soft and pliable. Next, it is bent around a rectangular form with the intersection 22 of the two widthwise edges being located proximate a bottom corner 24. In at least one manufacturing method, the entire sheet is heated, such as in an oven, to make the entire sheet pliable and is formed around the form in essentially a single operation. Using another manufacturing method, the sheet is laid against the form and the sections on the sheet corresponding to the various corners are locally heated, such as with a torch or heat gun, and then the sheet is bent at each corner in separate operations. Other manufacturing methods can be utilized as well as would be obvious to one of ordinary skill given the benefit of this disclosure. Upon cooling the sheet stiffens and becomes substantially rigid.

Referring to FIG. 3, the bottom edge of a vertical side corresponding to one widthwise edge is bonded to a top surface of the bottom side proximate the other widthwise edge at their intersection 22 at a bottom corner 24. When an acrylic sheet is utilized, a suitable solvent is typically used as a bonding agent to soften the corresponding portions of the sheet to facilitate the solvent welding or fusing of the sheet into the rectangular form. In other variations as may be necessary with certain other types of plastic sheet, adhesives can be utilized to form the joint. In at least one other variation that is not illustrated, the widthwise edges abut each other proximate an approximate center location of the bottom side wherein a thin strip of acrylic (or other plastic material as appropriate) is bonded across the two edges to form a lap joint.

In the joint illustrated in FIG. 3 after bonding, the corner 24 is typically rounded using a router to eliminate any sharp edges and to give the stand a more finished appearance.

Depending on the particular design, one or two substantially circular openings 12 are provided in the top side of the stand. A single opening is provided for a single feeder bowl elevated stand (not illustrated) and two openings are provided for a dual bowl elevated stand 10. The openings are sized to receive appropriately sized feeder bowls. The size of the feeder bowl to be received in any particular stand is ultimately dependent on the size of the stand itself. Larger stands typically have openings adapted to receive 3-quart bowls while medium-sized stands typically are adapted to receive 2-quart bowls and the smaller stands are adapted to receive 1-quart bowls. However, variations using bowls of any suitable size are contemplated.

The circular openings 12 can be cut or otherwise formed into the acrylic sheet at any suitable point during the manufacturing process. For instance the openings can be cut prior to the forming of the sheet into a rectangle or thereafter. The edges of the openings in some variations may be heat burnished to round off any sharp edges caused during the cutting process. Alternatively, the edges can be sanded or mechanically deburred as necessary.

The feeding bowls 16 are typically comprised of stainless steel and each has a flanged lip at the top edge of the bowl. The flanged lip rests on the top surface of the top side proximate an associated opening. In variations, the bowls can be made from any suitable material including, but not limited to, other metals, plastics and ceramics.

A set of four rubber/synthetic rubber feet 14 are coupled to the bottom surface of the bottom side of the stand proximate the four corners of the bottom side. It is appreciated that embodiments of the stand will not typically slide and move during use such as when a dog is eating, because rubber feet are provided to provide the necessary friction with hard surfaces to prevent excessive movement. In one variation, the feet are adhesively attached to the stand, although in others, the feet can be mechanically adhered, such as with screws.

Typically, the stand 10 is unadorned except for a decal or sticker indicating the name and manufacturer of the product. However, in certain variations, the stand may be adorned with decals 20. These decals may be pre-adhered to the sides and surfaces of the stand or they may be provided on a sheet separate of the stand to be optionally placed on the stand where a purchaser desires. Sheets of customizing decals may even be sold separately of the stand. Besides serving the purpose of decorating the stand, the stickers can help to make the stand more visible to people thereby reducing the risk that a person will unintentionally bump into the otherwise substantially transparent stand.

The stand 10 may be sold with or without the feeding bowls 16 but in at least one embodiment the bowls are included therewith. As indicated above, the bowls rest in the provided circular openings 12 and are generally held in place by way of gravity. During shipping and display, it is often desirable to better secure the bowls to an associated stand such that the bowls and stand do not become inadvertently separated. In at least one variation, a piece of cardboard sheet 18 is provided that at least partially wraps over the bowl(s) and is secured under a bottom surface of the top side proximate the cardboard sheet's widthwise edges. The edges are typically secured with an adhesive, such as a hot melt thermoplastic, but mechanical means, such as staples, can be used as well. The cardboard band typically includes information pertaining to the stand, often including product sizing information, product identifying indicia, and care/cleaning instuctions. In other variations, a plastic band can be utilized in place of the cardboard, or in other variations, other means may be utilized to secure the bowls in place, such as temporarily adhering the bowls in place with a removable adhesive.

### AN EMBODIMENT COMPRISING A SET OF NESTING PET FEEDING STANDS

Referring to FIGS. 4 & 5, one embodiment of the present invention comprises a set of differently sized stands 10A-H with or without the associated feeder bowls 16. FIG. 4 specifically illustrates eight differently sized dual feeder bowl stands for eight different sizes of dog. It is to be appreciated that a complete set of stands may include a greater or lesser number of sizes.

The set of eight stands has the following heights: 4″; 6″; 9″; 12″; 15″; 18″; 19″ and 23″ although the actual sizes can vary and sizes larger than 23″ can be offered as well. It is appreciated that sizes smaller than about 3-4″ are generally not practical as the height of a feeding bowls itself is about 2.5″-3.25″. However, a stand may still be desired because it keeps the two feeding bowls together and by virtue of the rubber feet reduces a pet's ability to move the bowls around while eating. The widths of the stands vary as well from about 18″ to about 22″, with the taller stands being wider than the shorter stands.

In one variation, the set comprises five standard size stands that vary in height from 6″ to 18″ with a three-inch difference in height between each size.

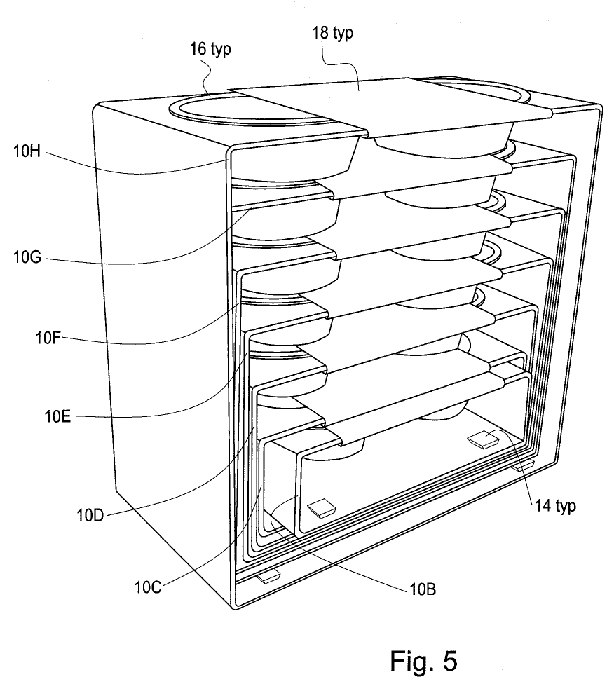

FIG. 5 illustrates seven different sizes of stands nested one within another such that the total exterior volume of the seven stands is equal to the volume of the largest stand. Each smaller stand is about 0.5″ shorter in length than the next largest stand and typically an inch or more shorter in height than the next larger stand, thereby permitting each smaller stand to nest within the next larger stand.

In reference to the set comprising the five standard sizes wherein the height of each successive size varies 3″ from the next smaller or larger size as applicable, the stands can be nested in their packages for retail configuration, including the feeding bowls and the cardboard bands 18 wrapped at least partially around the bowls to hold them securely in place. Simply, the 3″ or so difference in height permits the feeding bowls to hang down below the top side and rest, at least partially, on the top side of the next smaller holder's cardboard band.

Where the size difference between stands is less than 3″, the bowls may need to be removed from one or more of the holders for shipping, especially if the cardboard bands are installed around top side. In this situation, the removed bowls can be placed in one or more larger bowls of the set. For instance, a 2 quart bowl may be temporarily placed within a 3-quart bowl of a larger size stand.

Ultimately, the ability to nest a plurality of stands with or without the bowls permits the manufacturer and/or distributor to ship a complete or nearly complete set of stands in a single box just larger than the size of the largest stand. With a prior art set of feeding stands, the manufacturer and/or distributor has to individually ship each stand in its own box or ship multiple stands in very large boxes, thereby incurring increased shipping expense for the purchasing retailer. In contrast, by using nesting sets of stands as embodied herein, a single box of a small size can be used to ship an entire set, saving on shipping expense and thereby increasing the retailer's potential margin on the stands.

Aside from shipping expense, one of the main reasons that a retailer may not carry multiple prior art elevated stands is that they take up a significant amount of shelf or floor space within a pet shop. Feeding bowls and associated stands are generally not a high turnover item in a pet store unlike pet food and certain care products, such as shampoo and consumable toys. Accordingly, the potential return on shelf and floor space dedicated to bowls and stands is lower than that of high turnover items. Consequently, a retailer will limit the amount of space dedicated to low turnover items to maximize return by allocating additional space to high turnover items. Ultimately, only one or two sizes of prior art stands may be stocked.

Given the ability to nest a complete set of five, eight or more stands at a single location, taking up no more shelf space than stocking a single large stand, might facilitate the retailer carrying more sizes of elevated stands. Further, because a plurality of stands are displayed at a single location, the potential return per square foot of shelf/floor space is increased when compared to spreading as many prior art stands over much more shelf or floor space. Advantageously, the pet owner and his/her pets are better served by having the ability to choose and purchase a stand that is best suited for the pet(s) without difficulty or having to search around. This in turn may increase the pet owner's sense of loyalty to the particular store carrying the stands.

### OTHER EMBODIMENT AND OTHER VARIATIONS

The various preferred embodiments and variations thereof illustrated in the accompanying figures and/or described above are merely exemplary and are not intended to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

For instance, while the invention is described primarily in relation to being used with a transparent thermoplastic sheet material, other materials and methods of construction can be used in variations and other embodiments. Thermoplastic sheet that comprises a colored translucent sheet stock can also be used. Further, the sheet stock can be completely opaque. Other versions are contemplated that are made by alternative manufacturing means. For example, a seamless nestable version of the stand could be roto-molded in a variety of sizes.

Other elevated stand embodiments need not be fabricated from plastic at all. Versions bent and/or welded from sheet metal are contemplated. High-end glass versions can also be fabricated. Versions may also be constructed of wood. Simply, the nestable qualities of the elevated stand described herein are not limited to any particular material.

I claim:

1. A set comprising three or more elevated pet feeding bowl stands, each stand being differently sized from the other stands, and each smaller stand being adapted to nest within the next larger size stand.

2. The set of claim 1, wherein the set comprises at least five stands.

3. The set of claim 1, wherein the set comprises eight stands.

4. The set of claim 1, wherein each stand further includes one or two feeding bowls.

5. The set of claim 1, wherein each stand is substantially comprised of a single sheet of plastic material formed into a rectangular shape having a bottom side, opposing left and right sides, and a top side with openings provided for one or more pet feeding bowls.

6. The set of claim 5, wherein the front and rear sides of each stand are substantially open.

7. The set of claim 5, wherein a first widthwise edge of the single sheet of each stand is joined to a second widthwise edge of the single sheet.

8. The set of claim 7, wherein the joint between the first and second widthwise edges is located proximate an intersection of one of the left and right sides with the bottom side.

9. The set of claim 5, wherein each stand further includes four feet attached to the bottom side and the feet comprise a rubber or synthetic rubber material.

10. The set of claim 5, wherein each stand is substantially transparent.

11. The set of claim 5, wherein each stand is part of a stand assembly, each stand assembly comprising: (i) the stand; and (ii) one or two pet feeding bowls received into one or two corresponding openings.

12. The set of claim 11, further including a securing band, the securing band passing around the top side and at least partially over the one or two pet feeding bowls, the securing band including indicia printed thereon indicating the name of the stand and sizing information concerning the proper size stands for pets of various sizes.

13. A combination comprising the set of claim 1 and a shipping box wherein the plurality of stands are nested and contained within the shipping box.

14. A method of preparing the set of claim 11 for shipping, the method comprising: (i) nesting each smaller stand assembly into each next larger stand assembly; (ii) placing the nested stand assemblies within a shipping box; and labeling the box for shipment to another location.

15. A method of displaying the set of claim 11 for sale, the method comprising: (i) removing the set from a shipping box; and (ii) placing the plurality of stand assemblies in a nested configuration on a shelf or floor within a consumer accessible portion of a retail establishment, wherein the total footprint of the set comprises the about the area of the bottom side of a largest stand assembly.

16. A set comprising at least five differently sized elevated pet feeding bowl stands, each stand comprising a single piece of transparent thermoplastic material formed into a rectangular shape with one widthwise edge substantially abutting and being joined to the other widthwise edge, each stand having a bottom side, left and right sides and a top side with two circular openings provided therein adapted to receive two pet feeding bowls, each stand further including four rubber or synthetic rubber feet attached to a bottom surface of the bottom side, each smaller stand of the set being nested into a next larger stand wherein the at least five stands are substantially contained within the interior volume defined by a largest stand.

17. The set of claim 16, wherein each stand of the five differently sized elevated pet feeding bowl stands includes two feeding bowls.

18. The set of claim 16 wherein (i) a first stand of the five differently sized elevated pet feeding bowl stands has a height of about 6 inches, (ii) a second stand of the five differently sized elevated pet feeding bowl stands has a height of about 9 inches, (iii) a third stand of the five differently sized elevated pet feeding bowl stands has a height of about 12 inches, (iv) a fourth stand of the five differently sized elevated pet feeding bowl stands has a height of about 15 inches, and (v) a fifth stand of the five differently sized elevated pet feeding bowl stands has a height of about 18 inches.

19. An elevated pet feeding bowl stand comprising:
a single piece of thermoplastic material formed into a rectangular shape with one widthwise edge substantially abutting and being joined to the other widthwise edge, each stand having a bottom side, left and right sides and a top side with two circular openings provided therein adapted to receive two pet feeding bowls; and
four rubber or synthetic rubber feet attached to a bottom surface of the bottom side.

20. The elevated pet feeding bowl stand of claim 19, wherein the thermoplastic material is one of transparent or translucent.
